(19) United States
(12) Patent Application Publication
(10) Pub. No.: US 2018/0226729 A1
(43) Pub. Date: Aug. 9, 2018

(54) CIRCULARLY POLARIZED ANTENNA DEVICE

(71) Applicant: Joymax Electronics Co. , Ltd., Tauyuan Hsien (TW)

(72) Inventor: ShaoYi CHEN, Tauyuan Hsien (TW)

(21) Appl. No.: 15/428,187

(22) Filed: Feb. 9, 2017

(51) Int. Cl. H01Q 21/24; H01Q 1/48; H01Q 1/24

(52) U.S. Cl. CPC H01Q 21/24; H01Q 1/241; H01Q 1/48

(57) ABSTRACT

An antenna device includes a board disposed above a base plate, a number of conductor members disposed between the board and the base plate for separating the board from the base plate, and a ground plane formed on the base plate, a matching network includes a number of radiating members and a feed and a ground terminal disposed on the base plate, and the ground terminal is connected to the ground plane of the base plate, and a radiating device includes a number of radiating elements disposed on the board, and the conductor members are connected to the ground plane of the base plate, and connected to the matching network, and also connected to the radiating elements of the radiating device respectively.

### BACKGROUND OF THE INVENTION

### 1. Field of the Invention

The present invention relates to an antenna device for attaching onto various objects, and more particularly to a circularly polarized antenna device.

### 2. Description of the Prior Art

Various kinds of typical polarized antenna devices have been developed and arranged for receiving and/or transmitting signals from polarized directions. For example, horizontally polarized antenna devices may be provided for receiving and/or transmitting horizontally polarized signals, but may not be used for receiving and/or transmitting vertically polarized signals. On the contrary, vertically polarized antenna devices may be provided for receiving and/or transmitting vertically polarized signals, but may not be used for receiving and/or transmitting horizontally polarized signals. Monopole Antenna devices, and inverse F antenna devices may also be used for receiving and/or transmitting the other signals.

Various kinds of typical circularly polarized antenna devices have been developed and arranged for receiving and/or transmitting circularly polarized signals, and for providing the capability of controlling various facilities or systems, such as Global Positioning Systems (GPS), Global System for Mobile Communications (GSM), Radio Frequency Identification (RFID), etc. For example, right hand circularly polarized antenna devices (RHCP) may be provided for receiving and/or transmitting right hand circularly polarized signals, and left hand circularly polarized antenna devices (LHCP) may be provided for receiving and/or transmitting left hand circularly polarized signals.

For example, U.S. Pat. No. 7,541,988 to Sanelli et al., U.S. Pat. No. 7,548,207 to Chu et al., U.S. Pat. No. 7,598,914 to Chang, U.S. Pat. No. 7,782,266 to Chang et al., U.S. Pat. No. 8,674,884 to Lin et al., U.S. Pat. No. 8,797,230 to Leisten, U.S. Pat. No. 8,917,217 to Sze et al., U.S. Pat. No. 9,070,971 to Johnston, U.S. Pat. No. 9,112,259 to Lin, U.S. Pat. No. 9,130,278 to Palevsky et al., U.S. Pat. No. 9,190,734 to Niver et al., U.S. Pat. No. 9,252,500 to Orban et al., U.S. Pat. No. 9,287,623 to Lindenmeier et al., U.S. Pat. No. 9,300,047 to Lindenmeier et al., U.S. Pat. No. 9,419,347 to Xue et al., and U.S. Pat. No. 9,431,713 to Singh disclose several of the typical circularly polarized antenna devices.

However, the typical circularly polarized antenna devices normally comprise a simplified structure or configuration having a heavy base dielectric substrate or ground plane which may be easily damaged while dropping or hitting onto the ground or the like. In addition, the typical circularly polarized antenna devices comprise a complicated structure or configuration that may not be easily made or manufactured and that may include a complicated making or manufacturing procedure and that may include a greatly increased manufacturing cost.

The present invention has arisen to mitigate and/or obviate the afore-described disadvantages of the conventional circularly polarized antenna devices.

### SUMMARY OF THE INVENTION

The primary objective of the present invention is to provide a circularly polarized antenna device for attaching onto various telecommunicating facilities or appliances.

In accordance with one aspect of the invention, there is provided a circularly polarized antenna device comprising a base plate, a board disposed above the base plate, a number of conductor members disposed between the board and the base plate for separating the board from the base plate, a ground plane provided on the base plate, a matching network including a number of radiating members and a feed and a ground terminal disposed on the base plate, and the ground terminal being connected to the ground plane of the base plate, and a radiating device including a number of radiating elements disposed on the board, and the conductor members being connected to the ground plane of the base plate, and the conductor members being connected to the matching network, and the conductor members being connected to the radiating elements of the radiating device respectively.

The radiating members of the matching network includes a first radiating member, a second radiating member connected to the first radiating member, a third radiating member connected to the first radiating member, a fourth radiating member, a fifth radiating member connected to the fourth radiating member, and a sixth radiating member connected to the fourth radiating member, the feed is electrically connected to the first and the fourth radiating members.

The conductor members are connected to the second, the third, the fifth, and the sixth radiating members of the matching network. The second, the third, the fifth, and the sixth radiating members of the matching network each include a free end portion extended toward a side portion of the base plate and connected to the conductor members.

The conductor members each include a first leg attached to the board, a second leg attached to the base plate and connected to the free end portions of the second, the third, the fifth, and the sixth radiating members of the matching network respectively, and a third leg attached to the base plate and connected to the ground plane. The base plate includes a ground layer connected to the ground plane and connected to the third legs of the conductor members.

The base plate includes a compensate resistor connected to the first and the fourth radiating members, and/or a compensate resistor connected to the second and the third radiating members, and/or a compensate resistor connected to the fifth and the sixth radiating members. The compensate resistor may be selected from a chip resistor, and may include a resistance ranged between 50-150 Ohms, such as 100 Ohms.

The first radiating member, the first and the second radiating members, the third and the fourth radiating members, and the fourth and the fifth and the sixth radiating members include path lengths arranged in a ratio of 1:2:3:4.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a circularly polarized antenna device in accordance with the present invention;

FIG. 2 is a side plan schematic view of the circularly polarized antenna device;

FIG. 3 is a partial exploded view of the circularly polarized antenna device as seen from the upper portion of the circularly polarized antenna device;

FIG. 4 is another partial exploded view as seen from the bottom portion of the circularly polarized antenna device;

FIG. 5 is a diagram illustrating the operation of the circularly polarized antenna device, and illustrating the voltage standing wave ratio; and

FIG. 6 is another diagram illustrating the return loss of the circularly polarized antenna device.

### DETAILED DESCRIPTION OF THE PREFERRED EMBODIMENT

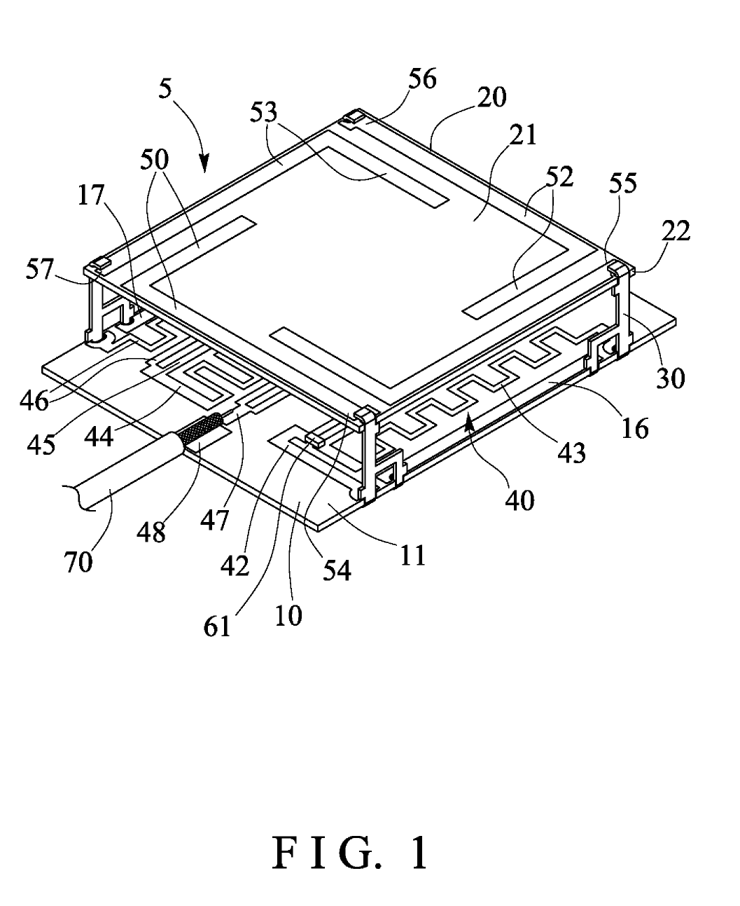

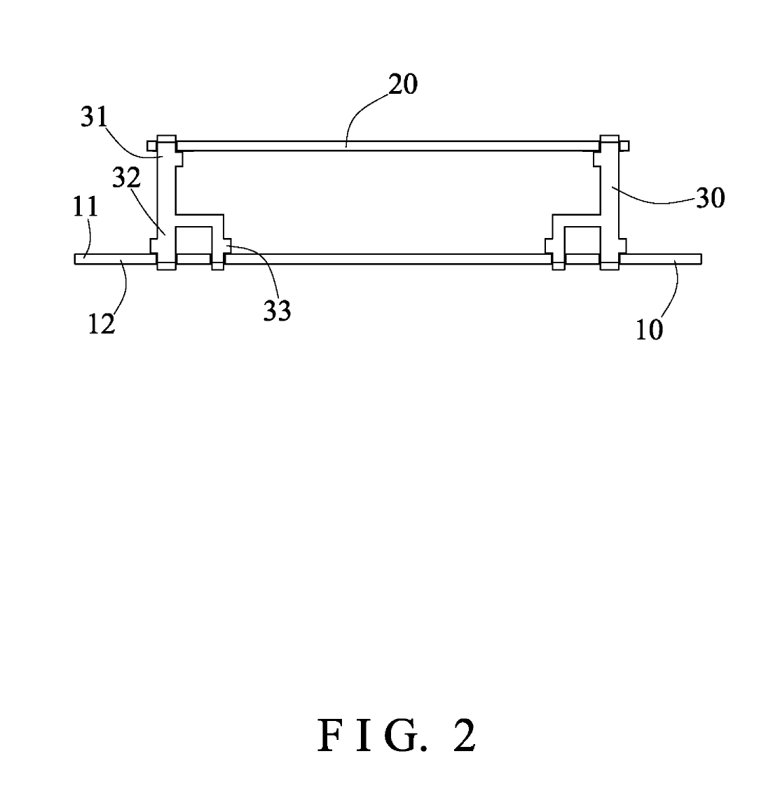

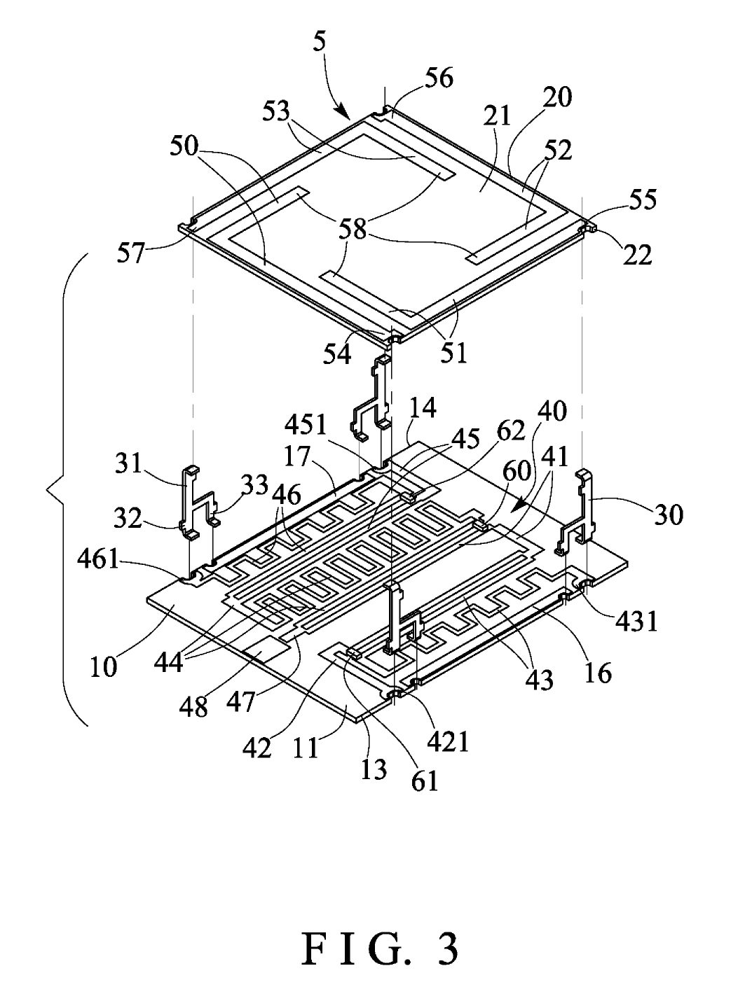

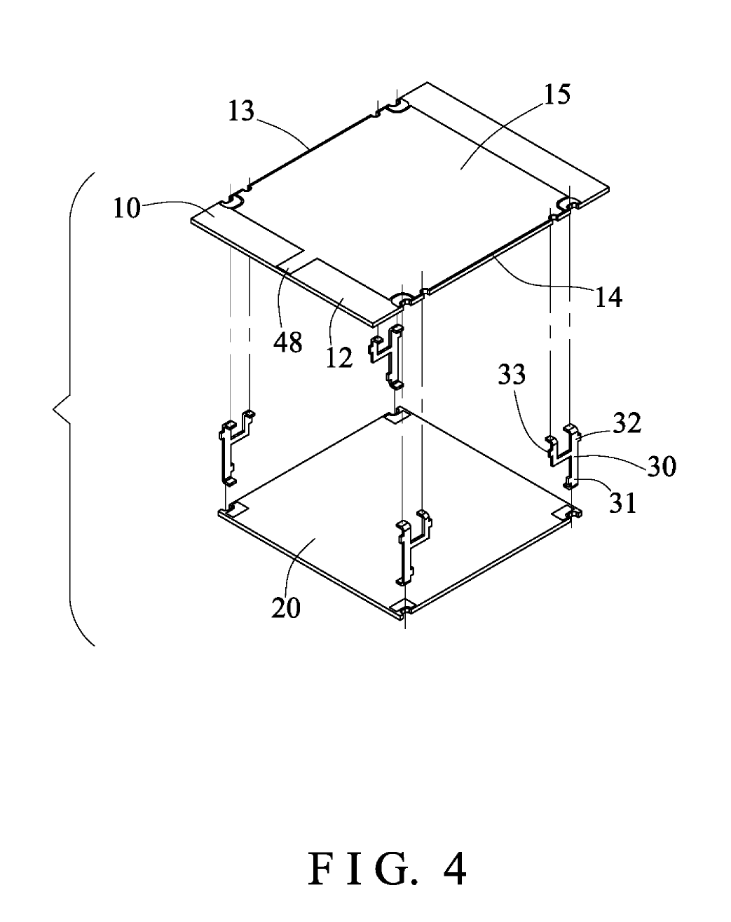

Referring to the drawings, and initially to FIGS. 1-4, a circularly polarized antenna device in accordance with the present invention is provided for attaching onto various electrical or telecommunicating facilities or other appliances, and the circularly polarized antenna device comprises a dielectric substrate or ground plane layer or base or first plate 10, and a cover or upper or second plate or board 20 to be supported on and above and offset or spaced or separated from the base or first plate 10 with one or more (such as four) conductor members 30, best shown in FIGS. 1 and 2. The base plate 10 includes an upper or first surface 11 (FIGS. 1, 3), and a lower or bottom or second surface 12 (FIG. 4) having marginal side portions 13, 14.

A matching system or network 40 is disposed or attached or mounted or applied onto the upper or first surface 11 of the base plate 10, and includes a first radiating member 41, a second radiating member 42 electrically connected or coupled to the first radiating member 41, a third radiating member 43 electrically connected or coupled to the first radiating member 41, a fourth radiating member 44 electrically connected or coupled to the first radiating member 41, a fifth radiating member 45 electrically connected or coupled to the fourth radiating member 44, and a sixth radiating member 46 electrically connected or coupled to the fourth radiating member 44, an electrical feed 47 is electrically connected or coupled to the first and the fourth radiating members 41, 44, and a ground terminal 48 is applied onto or provided on either or both of the first and the second surfaces 11, 12 of the base plate 10 (FIGS. 1, 3, 4).

As best shown in FIG. 3, the second, the third, the fifth, and the sixth radiating members 42, 43, 45, 46 each include a free end portion 421, 431, 451, 461 extended toward the marginal side portions 13, 14 of the base plate 10. The base plate 10 further includes a ground plane 15 formed or provided or applied onto the second surface 12 of the base plate 10 (FIG. 4) and connected or coupled to the ground terminal 48; and one or more (such as two further) ground planes or layers 16, 17 are formed or provided or applied onto the first surface 11 of the base plate 10 (FIGS. 1, 3) and connected or coupled to the ground plane 15; or the ground layers 16, 17 are the extension of the ground plane 15.

A radiating device 5 includes one or more (such as four) radiating elements 50, 51, 52, 53 disposed or attached or mounted or applied onto the upper or first surface 21 of the board 20, and each radiating element 50-53 having a substantially L-shaped structure or configuration, and the radiating elements 50-53 are arranged either clockwise or counter-clockwise on the board 20 (FIGS. 1, 3) and each include an outer free end portion 54, 55, 56, 57 extended toward the corner areas 22 of the board 20, and the radiating elements 50-53 each include an inner free end portion 58. The radiating elements 50-53 of the radiating device 5 and the radiating members 41-46 of the matching network 40 and the electrical feed 47 and the ground terminal 48 are made or manufactured with or formed by metallic or conductive materials and formed or printed or applied onto the board 20 and the base plate 10 respectively.

The conductor members 30 are arranged perpendicular to the board 20 and the radiating elements 50-53 of the radiating device 5, and also arranged perpendicular to the base plate 10 and the radiating members 41-46 of the matching network 40, and the conductor members 30 each may include a substantially h-shaped structure or configuration. For example, the conductor members 30 each include a first limb or leg 31 attached or mounted or secured to the board 20 and electrically connected or coupled to the outer end portions 54-57 of the radiating elements 50-53 of the radiating device 5, and a second limb or leg 32 attached or mounted or secured to the base plate 10 and electrically connected or coupled to the free end portions 421, 431, 451, 461 of the second, the third, the fifth, and the sixth radiating members 42, 43, 45, 46 respectively, and a third limb or leg 33 also attached or mounted or secured to the base plate 10 and electrically connected or coupled to the ground plane 15 and/or the ground layers 16, 17.

The conductor members 30 and the radiating elements 50-53 of the radiating device 5 may thus be formed as an inverted F antenna. It is preferable, but not necessary that the path lengths of the first radiating member 41, the first and the second radiating members 41, 42, the third and the fourth radiating members 43, 44, and the fourth and the fifth and the sixth radiating members 44, 45, 46 are arranged in a ratio of 1:2:3:4 or the like. A compensate resistor 60 may further be provided and attached or mounted or secured or connected or coupled to the first and the fourth radiating members 41, 44, and another compensate resistor 61 may further be provided and connected or coupled to the second and the third radiating members 42, 43, and a further compensate resistor 62 may further be provided and connected or coupled to the fifth and the sixth radiating members 45, 46. The compensate resistors 60-62 may be selected from a chip resistor or the like, and may include a resistance ranged between 50-150 Ohms, such as 100 Ohms.

In operation, as shown in FIG. 1, an electrical feeding line 70 may further be provided and connected or coupled to the electrical feed 47 and the ground terminal 48, and arranged for allowing the radiating elements 50-53 of the radiating device 5 to transmit and/or receive signals or the like. It is to be noted that the board 20 and the base plate 10 may be selected from the printed circuit boards or the like and may be solidly and stably secured and connected together with the conductor members 30 such that the weight of the circularly polarized antenna device may be suitably decreased, and the manufacturing procedure may be simplified and the manufacturing cost may be decreased.

The conductor members 30 and the radiating elements 50-53 of the radiating device 5 may be formed as an inverted F antenna; and the path lengths of the first radiating member 41, the first and the second radiating members 41, 42, the third and the fourth radiating members 43, 44, and the fourth and the fifth and the sixth radiating members 44, 45, 46 are arranged in a ratio of 1:2:3:4 or the like, for allowing the amplitude of the paths to be equal to each other, and the phase angles of the paths may have a ninety (90) degrees difference from each other, and arranged for allowing the phase angles of the signals input from the feed 47 to be formed as 0 degree, 90 degree, 180 degree, and 270 degree, and so as to form as a distributor, and for allowing the signals to be suitably transmitted and separated and distributed to the radiating elements 50-53 of the radiating device 5 with the conductor members 30.

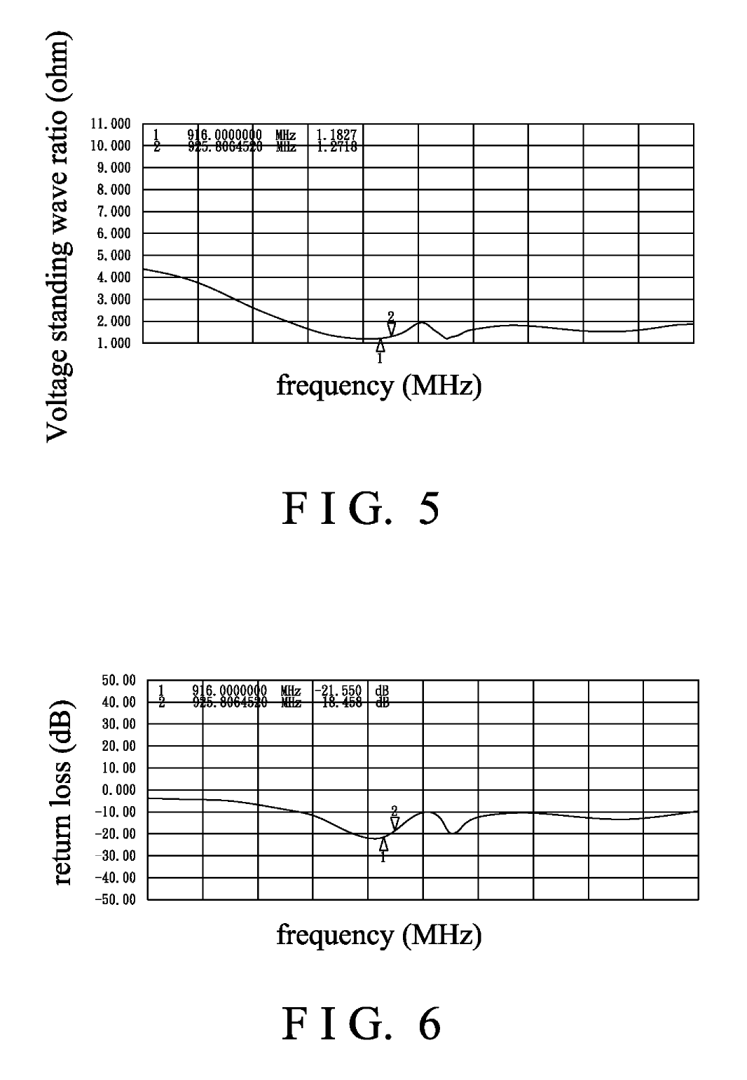

The compensate resistors 60-62 may make sure that the phase angles of the signals input from the feed 47 to the radiating elements 50-53 of the radiating device 5 to be precisely at 0 degree, 90 degree, 180 degree, and 270 degree respectively. It is further to be noted that the circularly polarized antenna device in accordance with the present invention may be effectively worked in a wide range of frequencies, such as the ultra high frequency (UHF) of the radio frequency identification (RFID), the frequency will be ranged between 860-930 MHz or the like, and may form the wave shape as shown in FIGS. 5 and 6. It is preferable that the matching resistance of the voltage standing wave ratio in FIG. 5 may be obtained at about 1.1827, and not exceeded 1.2718. As shown in FIG. 6, the return loss may be obtained at about −21.55 dB, and not exceeded −18.458 dB.

Accordingly, the circularly polarized antenna device in accordance with the present invention may be provided for attaching onto various telecommunicating facilities or appliances.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A circularly polarized antenna device comprising:
a base plate,
a board disposed above said base plate,
a plurality of conductor members disposed between said board and said base plate for separating said board from said base plate,
a ground plane provided on said base plate, -
a matching network including a plurality of radiating members and a feed and a ground terminal disposed on said base plate, and said ground terminal being connected to said ground plane of said base plate, and
a radiating device including a plurality of radiating elements disposed on said board, and
said conductor members being connected to said ground plane of said base plate, and said conductor members being connected to said matching network, and said conductor members being connected to said radiating elements of said radiating device respectively.

2. The circularly polarized antenna device as claimed in claim 1, wherein said radiating members of said matching network includes a first radiating member, a second radiating member connected to said first radiating member, a third radiating member connected to said first radiating member, a fourth radiating member, a fifth radiating member connected to said fourth radiating member, and a sixth radiating member connected to said fourth radiating member, said feed is connected to said first and said fourth radiating members.

3. The circularly polarized antenna device as claimed in claim 2, wherein said conductor members are connected to said second, said third, said fifth, and said sixth radiating members of said matching network.

4. The circularly polarized antenna device as claimed in claim 3, wherein said second, said third, said fifth, and said sixth radiating members of said matching network each include a free end portion extended toward a side portion of said base plate and connected to said conductor members.

5. The circularly polarized antenna device as claimed in claim 4, wherein said conductor members each include a first leg attached to said board, a second leg attached to said base plate and connected to said free end portions of said second, said third, said fifth, and said sixth radiating members of said matching network respectively, and a third leg attached to said base plate and connected to said ground plane.

6. The circularly polarized antenna device as claimed in claim 5, wherein said base plate includes a ground layer connected to said ground plane and connected to said third legs of said conductor members.

7. The circularly polarized antenna device as claimed in claim 2, wherein said base plate includes a compensate resistor connected to said first and said fourth radiating members.

8. The circularly polarized antenna device as claimed in claim 7, wherein said compensate resistor is a chip resistor.

9. The circularly polarized antenna device as claimed in claim 7, wherein said compensate resistor includes a resistance ranged between 50-150 Ohms.

10. The circularly polarized antenna device as claimed in claim 7, wherein said compensate resistor includes a resistance of 100 Ohms.

11. The circularly polarized antenna device as claimed in claim 2, wherein said base plate includes a compensate resistor connected to said second and said third radiating members.

12. The circularly polarized antenna device as claimed in claim 11, wherein said compensate resistor is a chip resistor.

13. The circularly polarized antenna device as claimed in claim 11, wherein said compensate resistor includes a resistance ranged between 50-150 Ohms.

14. The circularly polarized antenna device as claimed in claim 11, wherein said compensate resistor includes a resistance of 110 Ohms.

15. The circularly polarized antenna device as claimed in claim 2, wherein said base plate includes a compensate resistor connected to said fifth and said sixth radiating members.

16. The circularly polarized antenna device as claimed in claim 15, wherein said compensate resistor is a chip resistor.

17. The circularly polarized antenna device as claimed in claim 15, wherein said compensate resistor includes a resistance ranged between 50-150 Ohms.

18. The circularly polarized antenna device as claimed in claim 15, wherein said compensate resistor includes a resistance of 100 Ohms.

19. The circularly polarized antenna device as claimed in claim 2, wherein said first radiating member, said first and said second radiating members, said third and said fourth radiating members, and said fourth and said fifth and said sixth radiating members include path lengths arranged in a ratio of 1:2:3:4.
